(19) United States
(12) Patent Application Publication
(10) Pub. No.: US 2008/0211963 A1
(43) Pub. Date: Sep. 4, 2008

(54) Equipment For Audio-Video Processing System

(75) Inventors: Geert Gerardus Vanderheijden, Haaren (NL); Romke Kats, Eindhoven (NL); Richard Ansfriedus Snijders, Eindhoven (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/915,401

(22) PCT Filed: May 8, 2006
(86) PCT No.: PCT/IB06/51433

§ 371 Date: Nov. 26, 2007

(30) Foreign Application Priority Data
May 24, 2005 (EP) 05104377.6

(51) Int. Cl. H04N 5/067; H04N 5/14; H04N 5/60

(52) U.S. Cl. 348/515; 348/571; 348/738; 348/E05.062; 348/E05.014; 348/E05.122

(57) ABSTRACT

The invention provides a processing system, comprising a video signal processing unit for processing a video signal, the video signal processing entailing a video signal processing delay, and video delay control for controlling said video signal processing unit in dependence on a maximum allowed value for the video signal processing delay. The invention also provides an audio-video signal source, comprising an output for sending a video signal to a video signal processing unit, and an output for communicating to the video signal processing unit a maximum allowed value for a video signal processing delay entailed by video signal processing in the video signal processing unit. The invention further provides an audio signal processing unit, comprising an audio signal processing unit, said audio signal processing entailing an audio signal processing delay not exceeding a maximum audio delay, and an output for communicating to the video signal processing unit a maximum allowed value for a video signal processing delay entailed by video signal processing in the video signal processing unit, the maximum allowed value for the video signal processing delay depending on the maximum audio delay.

The invention relates to equipment for use in an audio-video processing system.

U.S. Pat. No. 5,202,761 discloses an audio synchronizer apparatus having a delay detector for accurately measuring the delay of a video apparatus, coupled with a controllable, variable delay audio delay circuit for accurately delaying an audio frequency signal by substantially the same amount as the video signal delay. A typical connection to the audio synchronizer is shown where an alternate delay input from an external video processing device is input through an optional interface.

It is, inter alia, an object of the invention to provide improved equipment for use in an audio-video processing system. The invention is defined by the independent claims. Advantageous embodiments are defined in the dependent claims.

One aspect of the invention is based on the insight that the prior art fails to provide a solution applicable if the audio part of the AV system is not able to match all possible delays in the video part of the AV system, and/or if content is coming from a game console so that video processing delays exceeding a certain maximum delay are simply unacceptable because they would spoil the game. With these concerns in mind, the invention provides a video delay control for controlling the video signal processing in dependence on a maximum allowed value for the video signal processing delay. Based on this maximum allowable delay, the video signal processing can be limited to modes that do not entail video processing delays exceeding the maximum allowable delay.

The invention thus provides a processing system, comprising a video signal processing unit for processing a video signal, the video signal processing entailing a video signal processing delay, and video delay control for controlling said video signal processing unit in dependence on a maximum allowed value for the video signal processing delay. The invention also provides an audio-video signal source, comprising an output for sending a video signal to a video signal processing unit, and an output for communicating to the video signal processing unit a maximum allowed value for a video signal processing delay entailed by video signal processing in the video signal processing unit. The invention further provides an audio signal processing unit, comprising an audio signal processing unit, said audio signal processing entailing an audio signal processing delay not exceeding a maximum audio delay, and an output for communicating to the video signal processing unit a maximum allowed value for a video signal processing delay entailed by video signal processing in the video signal processing unit, the maximum allowed value for the video signal processing delay depending on the maximum audio delay.

These and other aspects of the invention will be apparent from and elucidated with reference to the embodiments described hereinafter.

In the drawings:

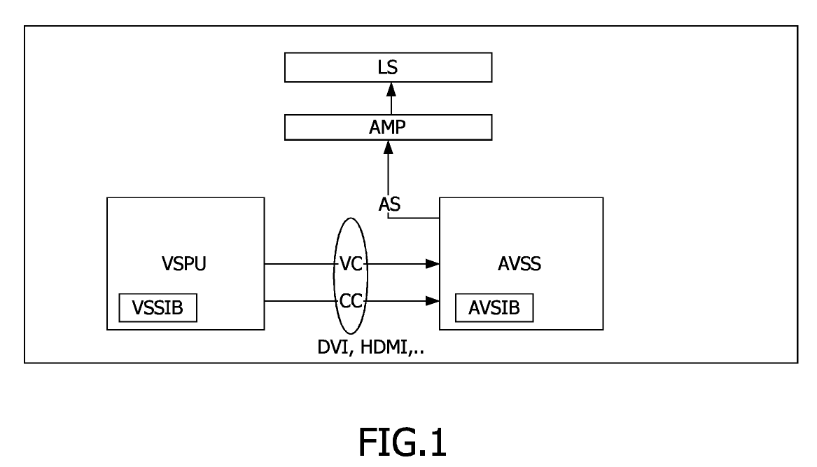

FIG. 1 shows an embodiment of a system in accordance with the present invention;

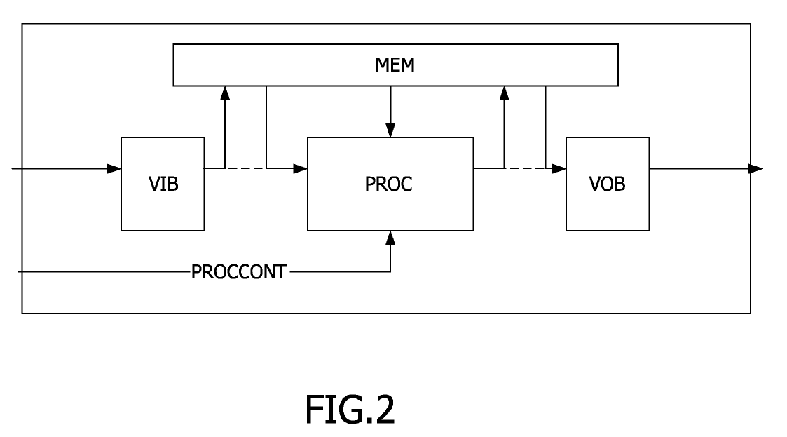

FIG. 2 shows an embodiment of a video processing unit in accordance with the present invention; and

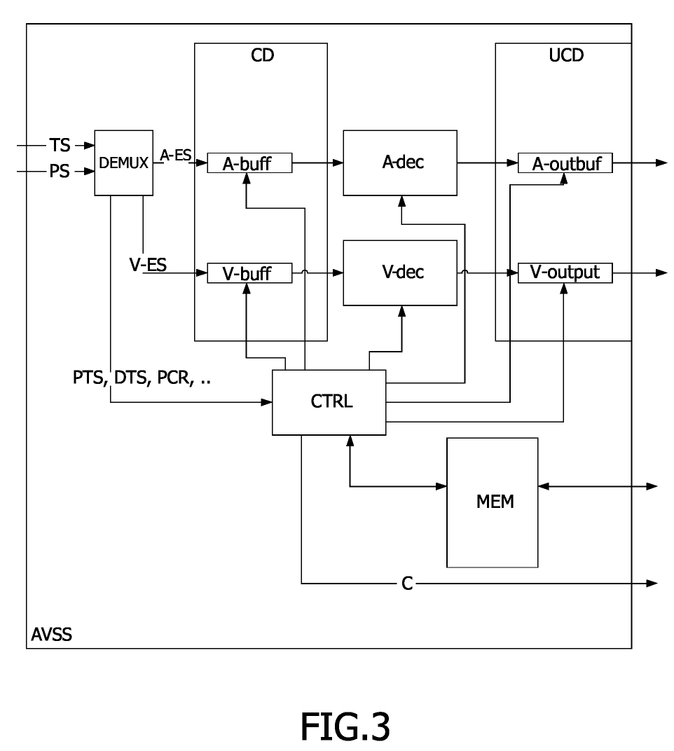

FIG. 3 shows an embodiment of an audio-video signal source in accordance with the present invention.

An embodiment of a system operation in accordance with the present invention is as follows. An audio video signal source AVSS, for example a content system, will decode and/or generates audio and video. This can be a DVD player, a home-cinema set, but also a Set-Top box or a game console. So, the content may originate from a DVD, a network, or be locally generated. The user will hear the audio signal AS via the loudspeakers LS with an optional amplifier AMP in-between. This amplifier is optional, because a home-cinema system may have a direct connection to the loudspeakers.

The video signal is going directly to a video signal processing unit VSPU formed by a TV-set or monitor via an analog or digital interface. In addition to the video channel VC there can be a communication channel CC, for instance CEC, DDC as in DVI and HDMI or an AV-link as in some analog TV systems. The video signal processing unit VSPU will process the video signal, and associated to that it may introduce delay in the presentation of the video on the display. This delay is dependent on the processing in the video signal processing unit VSPU (e.g. a TV system), which may be dependent on the video content (film, video, interlaced, progressive, etc.), but also on the user preference (who can force the processing in a specified mode/preferences). The information about the delay that is associated with a certain mode/user preference, is stored in the capabilities/status information block VSSIB, which could be accessible via the communication channel from the content system. That information can be used to change the audio processing delay in the content system.

The following operations may exist:

### Forced Content System Mode:

The audio video signal source AVSS could read the capabilities from the video signal processing unit VSPU indicating the delays in certain modes when it starts to output content on the video signal. If the audio video signal source AVSS is a game console, it could force the video signal processing unit VSPU (by writing to a control location) into the lowest delay mode (needed for games). If the audio video signal source AVSS is a DVD player or a set-top box (STB), it could force the video signal processing unit VSPU into a mode that yields the best quality result on the display, or in a mode that depends on a maximum audio delay that the audio video signal source AVSS (STB/DVD) can compensate.

### Adaptive Mode:

The video signal processing unit VSPU receives the video content and will dynamically change the processing mode (dependent on content and user settings), as such it will update the capabilities/status information in the memory AVSIB which is accessible from the audio video signal source AVSS. Optionally, video signal processing unit VSPU may generate an interrupt to the audio video signal source AVSS (using the communication channel) to indicate the change. The audio video signal source AVSS can periodically sense the status register or optionally respond to the interrupt and change the audio delay according the status and closest to the associated delay. In case the video signal processing unit VSPU is not the last unit in a processing chain (if there are additional systems behind it with the same interface), the video signal processing unit VSPU will need to add its delay to the delay of the other devices, or the content system has to read all delays in the chain and add them.

### Forced TV System Mode:

It is also possible that the video signal processing unit VSPU reads the capabilities from the audio video signal source AVSS (on delay possibilities) and will force the audio video signal source AVSS to additionally delay the audio dependent of its own video processing delay.

FIG. 2 shows an embodiment of a video processing unit in accordance with the present invention. An input video signal is applied to a video input buffer VIB. An output of the video input buffer VIB is connected to a memory MEM for processing and additional delay, and to a processing unit PROC for e.g. de-interlacing and scaling. The processing unit PROC is controlled by a processing control signal PROCCONT. Outputs of the memory MEM and the processing unit PROC are connected to a video output buffer VOB. In this embodiment, the following processing modes are available:

| Processing Mode | Delay | Video Quality |
|---|---|---|
| line copy (de-interlace) | 2 lines (128 μs) | — |
| 2 fields | 1 field (20 ms) | 0 |
| 3 fields | 2 fields (40 ms) | + |
| 4 fields | 3 fields (60 ms) | ++ |
| motion-compensated | 2.5 fields (50 ms) | ++ |
| motion-compensated (high quality) | 3.5 fields (70 ms) | +++ |

Clearly, the examples in the above table depend on the video standard; the indicated times relate to the PAL standard. Depending on an amount of free memory, additional delay is possible in all modes.

FIG. 3 shows an embodiment of an audio-video signal source AVSS in accordance with the present invention. Herein,

TS=Transport stream input (for a set top box)
PS=Program stream input (for a DVD or a set top box)
ES=elementary stream (only video or audio information)
PTS=Presentation Time Stamp (indicates when the picture or audio samples have to be presented on screen or speakers)
DTS=decoding time stamp (indicates when do you need to decode the images/sound, used for reordering)
PCR=program clock recovery (is used to synchronize the receiver clock to the encoder clock).

The signals TS and PS are applied to a demultiplexer DEMUX for generating an audio elementary stream A-ES, a video elementary stream V-ES, and signals PTS, DTS and PCR. In a compressed domain CD, there is an audio buffer A-buff receiving the audio elementary stream A-ES, and a video buffer V-buff receiving the video elementary stream V-ES. The audio and video buffers A-buff and V-buff are controlled by a PLL/sync processing and delay control unit CTRL that receives the signals PTS, DTS and PCR. Signals from the audio and video buffers A-buff and V-buff are respectively applied to an audio decoder A-dec and a video decoder V-dec, controlled by the PLL/sync processing and delay control unit CTRL. Signals from the audio and video decoders A-dec and V-dec are respectively applied to an audio output buffer A-outbuf and a video output buffer V-outbuf in an uncompressed domain UCD. The audio and video output buffers A-outbuf and V-outbuf are also controlled by the PLL/sync processing and delay control unit CTRL.

It is possible to delay the video and audio in the compression domain CD (after de-multiplexing), such that big buffers are not necessary. In case the PTS etc. are known, the clock control CTRL can delay depending on the requested output delay. The control CTRL also controls the decoder (using the decoding timestamps), and also the output (using the presentation time stamp), and it can be possible that at the output the buffers A-outbuf and V-outbuf are used to delay also the video and audio signals before presenting them to the display unit. The control unit CTRL is also used to communicate with the display unit on the settings, and a capabilities control memory MEM can be used by the display unit to read out the capabilities of the player. The control unit CTRL may also have a connection C for reading TV capabilities and write control.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim. The word “a” or “an” preceding an element does not exclude the presence of a plurality of such elements. The invention may be implemented by means of hardware comprising several distinct elements, and/or by means of a suitably programmed processor. In the device claim enumerating several means, several of these means may be embodied by one and the same item of hardware. The mere fact that certain measures are recited in mutually different dependent claims does not indicate that a combination of these measures cannot be used to advantage.

1. A processing system, comprising: a video signal processing unit for processing a video signal, said video signal processing entailing a video signal processing delay; and video delay control means for controlling said video signal processing unit in dependence on a maximum allowed value for said video signal processing delay.

2. A processing system as claimed in claim 1, further comprising an audio signal processing unit for processing an audio signal, said audio signal processing entailing an audio signal processing delay, wherein said maximum allowed value for said video signal processing delay depends on a maximum value of said audio signal processing delay.

3. A processing system as claimed in claim 1, further comprising a signal source applying the video signal and said maximum allowed value for said video signal processing delay to the video signal processing unit.

4. A video signal processing method, comprising: processing a video signal, said video signal processing entailing a video signal processing delay; and controlling said video signal processing in dependence on a maximum allowed value for said video signal processing delay.

5. An audio-video signal source, comprising: means for sending a video signal to a video signal processing unit; and means for communicating to the video signal processing unit a maximum allowed value for a video signal processing delay entailed by video signal processing in the video signal processing unit.

6. An audio signal processing unit, comprising: means for processing an audio signal, said audio signal processing entailing an audio signal processing delay not exceeding a maximum audio delay; and means for communicating to the video signal processing unit a maximum allowed value for a video signal processing delay entailed by video signal processing in the video signal processing unit, the maximum allowed value for the video signal processing delay depending on the maximum audio delay.
